(19) United States
(12) Patent Application Publication
(10) Pub. No.: US 2026/0261899 A1
(43) Pub. Date: Sep. 3, 2026

(54) QOS FLOW CONTROL METHOD, APPARATUS, AND COMPUTER STORAGE MEDIUM

(71) Applicant: Beijing Xiaomi Mobile Software Co., Ltd., Beijing (CN)

(72) Inventors: Jinhua WU, Beijing (CN); Yang SHEN, Beijing (CN); Jianning LIU, Beijing (CN); Yuxin MAO, Beijing (CN)

(21) Appl. No.: 18/995,647

(22) PCT Filed: Jul. 25, 2022
(86) PCT No.: PCT/CN2022/107722

§ 371 Date: Jan. 16, 2025

(51) Int. Cl. H04W 28/02; H04W 28/10

(52) U.S. Cl. CPC H04W 28/0221; H04W 28/10; H04W 28/0236; H04W 28/0268

(57) ABSTRACT

A quality of service (QOS) flow control method is performed by an access network function. The method includes: receiving terminal status information from a first core network function, wherein the terminal status information is configured to represent a power consumption status of a terminal; determining a first QoS profile for one or more QOS flows associated with the terminal from one or more alternative QoS profiles according to the terminal status information; and sending the first QoS profile to a second core network function, wherein the first QoS profile is configured for at least one of the terminal, the second core network function, a third core network function, or an application function (AF) to perform a QoS update.

### CROSS REFERENCE TO RELATED APPLICATIONS

The present application is a U.S. national phase of International Application No. PCT/CN 2022/107722, filed on Jul. 25, 2022, the disclosure of which is incorporated herein by reference in its entirety.

### TECHNICAL FIELD

The present disclosure relates to the field of wireless communication technology, and in particular to quality of service (QOS) flow control methods and apparatuses, and a computer storage medium.

### BACKGROUND

In the fifth generation mobile networks (5G) technology, mobile media services, cloud extended reality (XR), cloud games, remote control of machines or drones based on video and the like are expected to contribute more and more traffic to 5G networks.

At present, due to high throughput, low latency, and high reliability requirements of XR and media services, high power consumption on the terminal side is required, and a battery level of the terminal may affect the user experience.

So, how to match service traffic characteristics with terminal energy consumption management is an urgent problem to be solved.

### SUMMARY

The present disclosure provides quality of service (QOS) flow control methods and apparatuses, and a computer storage medium to match service traffic characteristics with terminal energy consumption management, thereby ensuring service requirements and user experience.

According to a first aspect of the present disclosure, there is provided a QoS flow control method, which can be applied to an access network function entity in a communication system. The method can include: receiving, by the access network function entity, terminal status information (UE status information) from a first core network function entity, where the terminal status information is configured to represent a power consumption status of a terminal; determining, by the access network function entity, a first QoS profile for one or more QoS flows associated with the terminal from one or more alternative QoS profiles according to the terminal status information; and sending, by the access network function entity, the first QoS profile to a second core network function entity, where the first QoS profile is configured for at least one of the terminal, the second core network function entity, a third core network function entity, or an application function (AF) entity to perform a QoS update.

According to a second aspect of the present disclosure, there is provided a QoS flow control method, which can be applied to a first core network function entity in a communication system. The method can include: receiving, by the first core network function entity, terminal status information sent by a terminal, where the terminal status information is configured to represent a power consumption status of the terminal; and sending, by the first core network function entity, the terminal status information to an access network function entity, where the terminal status information is further configured for the access network function entity to determine a first QoS profile for one or more QoS flows associated with the terminal from one or more alternative QoS profiles, where the first QoS profile is configured for the terminal, a second core network function entity, a third core network function entity, and an application function (AF) entity to perform a QoS update.

According to a third aspect of the present disclosure, there is provided a QoS flow control method, which can be applied to a third core network function entity in a communication system. The method can include: receiving, by the third core network function entity, a first QoS profile sent by an access network function entity, where the first QoS profile is a QoS profile for one or more QoS flows associated with a terminal determined by the access network function entity from one or more alternative QoS profiles according to terminal status information of the terminal; and performing, by the third core network function entity, at least one of: performing a QoS update on the one or more QoS flows associated with the terminal according to the first QoS profile; or sending the first QoS profile to an application function (AF) entity, where the first QoS profile is configured for the the AF entity to perform a QoS update.

According to a fourth aspect of the present disclosure, there is provided a communication apparatus, for example, an access network function entity, a first core network function entity, a second core network function entity, a third core network function entity, or an application function (AF) entity. The communication apparatus can include a memory and a processor. The processor is connected to the memory and configured to execute computer executable instructions stored on the memory to implement the QoS flow control method as described in the first to third aspects and any possible implementation thereof.

According to a fifth aspect of the present disclosure, there is provided a computer readable storage medium storing instructions which, when run on a computer, implement the QoS flow control method as described in the first to third aspects and any possible implementation thereof.

In the embodiment of the present disclosure, the UE status information of the UE is provided to the access network function entity through the first core network function entity (i.e., AMF entity), so that the access network function entity can match service traffic characteristics and terminal energy consumption management according to the UE status information, that is, select the corresponding QoS profile according to the power consumption status of the terminal, so as to ensure service requirements and user experience. Furthermore, the UE status information provided by the first core network function entity as additional information for policy determination can reduce the use of wireless interface network resources, especially in situations where resources are limited. Further, the UE status information of the UE is provided to the access network function entity through the first core network function entity, which can support the use of network resources according to capabilities of the terminal. Further, the UE status information of the UE is provided to the access network function entity through the first core network function entity, so that the user's critical application programs are allowed to run in the power saving mode, thereby improving the user experience and prolonging the battery life, instead of completely shutting down.

### BRIEF DESCRIPTION OF THE DRAWINGS

FIG. 1 is a schematic architectural diagram of a 5G communication system according to an embodiment of the present disclosure.

FIG. 2 is a schematic diagram of an implementation procedure of a first quality of service (QoS) flow control method according to an embodiment of the present disclosure.

FIG. 3 is a schematic diagram of an implementation procedure of a second QoS flow control method according to an embodiment of the present disclosure.

FIG. 4 is a schematic diagram of an implementation procedure of a third QoS flow control method according to an embodiment of the present disclosure.

FIG. 5 is a schematic diagram of an implementation procedure of a fourth QoS flow control method according to an embodiment of the present disclosure.

FIG. 6 is a schematic diagram of an implementation procedure of a fifth QoS flow control method according to an embodiment of the present disclosure.

FIG. 7 is a schematic structural diagram of a communication apparatus according to an embodiment of the present disclosure.

FIG. 8 is a schematic structural diagram of a communication apparatus according to an embodiment of the present disclosure.

FIG. 9 is a schematic structural diagram of a network function entity according to an embodiment of the present disclosure.

### DETAILED DESCRIPTION OF THE EMBODIMENTS

The exemplary embodiments will be described in detail herein, and examples thereof are shown in accompanying drawings. When the following descriptions refer to the accompanying drawings, unless otherwise indicated, the same numbers in different drawings represent the same or similar elements. The implementations described in the following exemplary embodiments do not represent all the implementations consistent with the embodiments of the present disclosure. Rather, they are merely examples of the apparatus and method consistent with some aspects of the embodiments of the present disclosure as detailed in the appended claims.

Terms used in the embodiments of the present disclosure are for the purpose of describing specific embodiments only, and are not intended to limit the embodiments of the present disclosure. The singular forms “a”, “an” and “this” used in the embodiments of the present disclosure and the appended claims are also intended to include plural forms, unless the context clearly indicates other meanings. It should also be understood that the term “and/or” as used herein refers to and includes any and all possible combinations of one or more of the associated listed items.

It should be understood that although terms first, second, third, and the like may be used in the embodiments of the present disclosure to describe various information, such information should not be limited to these terms. These terms are only used to distinguish the same type of information from each other. For example, first information may also be referred to as second information, and similarly, the second information may also be referred to as the first information without departing from the scope of the present disclosure. Depending on the context, the word “if” as used herein can be interpreted as “at the time of”, “when” or “in response to determining”.

Further, in the description of the embodiments of the present disclosure, “and/or” is only an association relationship for describing associated objects, indicating that three relationships can exist. For example, A and/or B can mean: A exists alone, A and B exist simultaneously, and B exists alone. In addition, in the description of the embodiments of the present disclosure, “a plurality of” may refer to two or more than two.

The technical solution of the embodiments of the present disclosure relates to an architecture of a communication system. The communication system can be a fifth generation mobile networks (5G) communication system or a future evolved communication system. In the architecture of the communication system, there are a terminal, an access network function entity (also described as an access network function, an access network element, an access network function component, an access network function module, etc.), and at least one core network function entity (also described as core network function, core network device, core network element, core network function component, core network function module, etc.). The at least one core network function entity is located in a core network (for example, 5GC). The terminal is used to report terminal status information (user equipment (UE) status information) for indicating its own power consumption status to the core network side. The at least one core network function entity has at least the following functions: providing received terminal status information to the access network function entity, receiving a first QoS profile determined by the access network function entity for one or more QoS flows associated with the terminal according to the terminal status information, performing a QoS update on the one or more QoS flows associated with the terminal according to the received first QoS profile, and sending the first QoS profile to a next level core network function entity for the next level core network function entity to perform a QoS update on the one or more QoS flows associated with the terminal. In practical applications, the above QoS flows are QoS flows of a first service of the terminal. The first service can include an extended reality (XR) service, a mobile media service and the like. The XR service and the mobile media service can also be referred to as an XRM service or described as an XR\M service.

Hereinafter, the embodiments of the present disclosure will be explained and illustrated by taking the 5G communication system as an example. It should be noted that the embodiments of the present disclosure are also applicable to any future evolved communication system after the 5G communication system, for example, the 6th generation mobile networks (6G) communication system, and the embodiments of the present disclosure do not specifically limit this. In various embodiments of the present disclosure, the 5G communication system can be equivalently replaced with a 6G communication system.

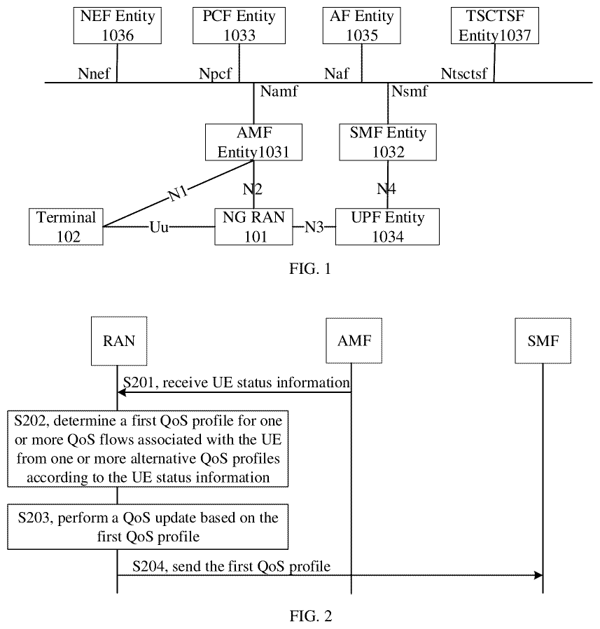

FIG. 1 is a schematic architectural diagram of a 5G communication system according to an embodiment of the present disclosure. Referring to FIG. 1, the above 5G communication system 100 can include a 5G radio access network (RAN) and a 5G core network (5GC). The 5G radio access network can include a next generation radio access network (NG RAN). The NG RAN 101 communicates with the terminal (or can be referred to as terminal device) 102 via a Uu interface. The 5G core network can include the above at least one core network function entity, for example, an access and mobility management function (AMF) entity 1031, a session management function (SMF) entity 1032, a policy control function (PCF) entity 1033, a user plane function (UPF) entity 1034, an application function (AF) entity 1035, a network exposure function (NEF) entity 1036, a time sensitive communication and time synchronization function (TSCTSF) entity 1037, etc. In the embodiment of the present disclosure, the above communication system can also include other network function entities (also referred to as network elements, network devices, etc.), which is not specifically limited in the embodiments of the present disclosure.

It should be noted that in FIG. 1, both a third-party (3rd) AF entity and an operator AF entity belong to the AF entity. The difference is that the third-party AF entity (for example, an instant messaging service server, an electronic payment service server, etc.) is not controlled by operators, and the operator AF entity (for example, a proxy-call session control function (P-CSCF) entity in an IP multimedia system) is controlled by operators. The third-party AF entity needs to interact with the PCF entity through the NEF entity. The above operator AF entity can also be described as a trusted AF entity, and the above third-party AF can also be described as an untrusted AF entity.

In addition, in order to make the description more concise, the “entity” in each function entity will be removed in the subsequent description. For example, the PCF entity is abbreviated as the PCF, the SMF entity is abbreviated as the SMF, and other entities are similar and will not be listed one by one.

In an embodiment of the present disclosure, in the above 5G communication system 100, the following interfaces can be set between various core network function entities.

N3: a communication interface between the UPF 1034 and the NG RAN 101.

N4: an interface between the SMF 1032 and the UPF 1034, which is used to transmit information between a control plane and a user plane (UP), including issuance of forwarding rules of the control plane to the UP, QoS control rules, traffic statistics rules, etc., and information reporting of the UP. N2: an interface between the AMF 1031 and the NG RAN 101, which is used to transmit radio bearer control information and the like from the core network side to the NG RAN 101.

N1: an interface between the AMF 1031 and the terminal 102, which is unrelated to access, and is used to transmit QoS control rules and the like to the terminal 102.

In FIG. 1, any two entities among the NEF, the PCF, the TSCTSF, the AMF, and the SMF can perform service-oriented communication with each other. For example, interfaces Nnef and Npcf used for communication between the NEF and the PCF are both service-oriented interfaces. Similarly, interfaces Naf, Ntsctsf, Namf, and Nsmf are service-oriented interfaces.

The above terminal can be a terminal device with a wireless communication function and a wireless sensing function, and can also be called user equipment (UE). The terminal can be deployed on land, including indoors or outdoors, handheld, wearable or vehicle-mounted. The terminal can also be deployed on water (for example, ships, etc.). The terminal can also be deployed in the air (for example, aircraft, balloons, satellites, etc.). The terminal may be a mobile phone, a tablet computer, a computer with a wireless transceiver function, a virtual reality (VR) terminal device, an augmented reality (AR) terminal device, or a wireless terminal in industrial control, a wireless terminal in self-driving, a wireless terminal in remote medical, a wireless terminal in smart grid, a wireless terminal in transportation safety, a wireless terminal in smart city, a wireless terminal in smart home, etc. The terminal may also be a handheld device, a vehicle-mounted device, a wearable device, a computing device having a wireless communication function and a wireless sensing function, or other processing device connected to a wireless modem, etc. Optionally, the terminal device can also be called by different names in different networks, for example, terminal device, access terminal, subscriber unit, subscriber station, mobile station, mobile table, remote station, remote terminal, mobile device, user terminal, terminal, wireless communication device, user agent or user apparatus, cellular telephone, cordless telephone, session initiation protocol (SIP) telephone, wireless local loop (WLL) station, personal digital assistant (PDA), terminal in 5G network or future evolved network, etc.

The above access network function entity can be a function entity used by the access network side to support communication terminals access the wireless communication system. For example, the access network function entity can be a next generation base station (for example, next generation NodeB, gNB), a transmission reception point (TRP), a relay node, an access point (AP) and the like in the 5G communication system.

It should be noted that in the communication system shown in FIG. 1, the various function entities and interfaces are only exemplary, and not all functions are necessary when the various function entities are applied to the embodiments of the present disclosure. The function entities of the access network and the core network can be physical devices or virtualized devices, which is not limited herein. The communication system in the embodiment of the present disclosure may also include other devices not shown in FIG. 1, which is not limited herein.

In the 5G network, mobile media services, XR, cloud games, remote control of machines or drones based on video and the like are expected to contribute more and more traffic to the 5G network, especially XR and media (XRM) services. The XRM services have characteristics of high throughput, low latency and high reliability requirements, which require high power consumption on the terminal side, and a battery level of the terminal may affect the user experience.

At present, based on the existing terminal implementation and considering service traffic characteristics, terminal power saving enhancement schemes have been defined in 3GPP. For example, power saving modes of the terminal in different connection managements (CMs), such as a CM-IDLE (idle state) power saving mode and a CM-CONNECTED (connected) power saving mode in a radio resource control (RRC) inactive state, a mobile initiated connection only (MICO) mode, an extended discontinuous reception (eDRX) mode and the like are also defined. However, the above schemes are specially designed for Internet of Things (IoT) terminals with ultra-low power consumption. If these schemes are used on smartphones, the user experience will be greatly affected.

Therefore, how to match service traffic characteristics with terminal energy consumption management is an urgent problem to be solved.

In the embodiments of the present disclosure, in the following embodiments, the terminal device in the communication system can take a UE as an example, a first core network function entity can take an AMF as an example, a second core network function entity can take an SMF as an example, a third core network function entity can take a PCF as an example, a fourth core network function entity can take other PCF as an example, and the application function (AF) entity can take an AF as an example to explain QoS flow control methods proposed in the embodiments of the present disclosure. In the 5G communication system and its evolved versions, the terminal, the access network function entity, the first core network function entity, the second core network function entity, the third core network function entity, the fourth core network function entity, and the AF entity may also be other function entities with the same or similar functions and connection relationships, which is not limited in the embodiments of the present disclosure.

In order to solve the above problems, in combination with the above communication system, an embodiment of the present disclosure provides a QoS flow control method.

FIG. 2 is a schematic diagram of an implementation procedure of a first QoS flow control method according to an embodiment of the present disclosure. As shown in FIG. 2, in this embodiment, the method is applied to an access network function entity (for example, a RAN) side, and the method can include S201 to S204.

In S201, the access network function entity receives terminal status information (UE status information) from an AMF.

The UE status information is used to represent a power consumption status of the UE. For example, the UE status information includes one or more parameters related to UE performance. For example, the UE status information may include at least one of the following: a UE battery level, a UE battery life, a UE powered mode, a UE central processing unit (CPU) load, a UE overheating status. In an embodiment of the present disclosure, parameters related to UE power consumption may include others. Here, the UE powered mode can include a battery-powered mode and a mains/wall-powered mode. Here, the battery-powered mode refers to using a built-in battery of the UE for power supply, and the mains/wall-powered mode refers to using a power adapter to connect to, for example, a wall socket, a mobile socket or the like, so as to connect to a power source to supply power to the UE.

It can be understood that the UE reports its own UE status information to the AMF, and then the AMF sends the UE status information to the access network function entity.

In an embodiment, in order to have no impact on the access network function entity and UE interfaces as far as possible, the UE may send the UE status information to the AMF through a non access stratum (NAS) message (for example, N2 SM information).

It should be noted that the above S201 can be multiplexed with a packet data unit (PDU) session establishment procedure. The above S201 can also be multiplexed in other procedures, which is not specifically limited in the embodiments of the present disclosure.

In S202, the access network function entity determines a first QoS profile for one or more QoS flows associated with the UE from one or more alternative QoS profiles according to the UE status information.

Here, the QoS profile can also be understood as a QoS level, and the QoS profile corresponds to the QoS level one by one.

It can be understood that a PCF can send one or more alternative QoS profiles to the access network function entity. After receiving the UE status information of the UE, the access network function entity can select a QoS profile (i.e., the first QoS profile) for the one or more QoS flows associated with the UE from the one or more alternative QoS profiles according to the power consumption status of the UE, so that a QoS update can be performed according to the QoS profile. It can be understood that the above “alternative” can also be described as “optional”, “replaceable”, “candidate”, etc.

Here, the one or more QoS flows associated with the UE can be related to a first service. In an embodiment of the present disclosure, the first service may be an XRM service, or an XRM service group.

In some implementations, the above QoS flows may be of different granularities, for example, QoS flows for sessions (i.e., session QoS flows), QoS flows for services (e.g., QoS flows of service data flows), which is not specifically limited in the embodiments of the present disclosure.

It can be understood that the access network function entity can determine the corresponding QoS profile for one or more sessions of a service (i.e., the first service) of the UE according to the UE status information. Or, the PCF can determine the corresponding QoS profile for a service (i.e., the first service) of the UE according to the UE status information. Here, “determine” can be described as “set”, “generate”, “update”, etc.

In some implementations, the one or more alternative QoS profiles mentioned above may include at least one of the following: a packet delay budget, a packet error rate, an uplink (UL) guaranteed bitrate, a downlink (DL) guaranteed bitrate, an averaging window, a maximum data burst volume, or a terminal status management indication. The terminal status management indication is configured to indicate whether the one or more alternative QoS profiles support application to terminal status management.

It can be understood that the above packet delay budget refers to a packet delay budget corresponding to the one or more alternative QoS profiles. The above packet error rate refers to a packet error rate corresponding to the one or more alternative QoS profiles. The above uplink guaranteed bitrate refers to an uplink guaranteed bitrate corresponding to the one or more alternative QoS profiles. The above downlink guaranteed bitrate refers to a downlink guaranteed bitrate corresponding to the one or more alternative QoS profiles. The above averaging window refers to an averaging window corresponding to the one or more alternative QoS profiles. The above maximum data burst volume refers to a maximum data burst volume corresponding to the one or more alternative QoS profiles. The above terminal status management indication is information indicating whether the one or more alternative QoS profiles are used for terminal status management.

It should be noted that in an embodiment of the present disclosure, QoS parameters (for example, alternative QoS parameter sets) in the alternative QoS profiles defined in the existing communication protocol are extended, so that extended alternative QoS profiles can be applied to both guaranteed bit rate (GBR) QOS flows and non GBR QOS flows.

In practical applications, the PCF can indicate to the access network function entity information on whether the one or more alternative QoS profiles are used for terminal status management by carrying a terminal status management indication in the one or more alternative QoS profiles. For example, carrying a terminal status management indication in the one or more alternative QoS profiles indicates information that the one or more alternative QoS profiles are used for terminal status management, and carrying no terminal status management indication in the one or more alternative QoS profiles indicates information that the one or more alternative QoS profiles are not used for terminal status management. Or, the PCF can indicate to the access network function entity information on whether the one or more alternative QoS profiles are used for terminal status management through a value of the terminal status management indication. For example, if the value of the terminal status management indication is a first value, it indicates information that the one or more alternative QoS profiles are used for terminal status management; if the value of the terminal status management indication is a second value, it indicates information that the one or more alternative QoS profiles are not used for terminal status management. The PCF can also adopt other manners to set the terminal status management indication, which is not specifically limited in the embodiments of the present disclosure.

Accordingly, in S202, after receiving the one or more alternative QoS profiles, the access network function entity can determine whether the one or more alternative QoS profiles are used for terminal status management according to the terminal status management indication, and then determine a QoS profile for the one or more QoS flows associated with the UE from one or more alternative QoS profiles used for terminal status management according to the UE status information.

In some implementations, the PCF can send one or more alternative QoS profiles used for terminal status management to the access network function entity. Upon receiving these alternative QoS profiles, the access network function entity will know that the received alternative QoS profiles are used for terminal status management and then perform S202.

In some implementations, the PCF can also receive alternative QoS profiles sent by an AF. Further, the PCF can determine the one or more alternative QoS profiles to be sent to the access network function entity according to QoS policies.

In some implementations, the PCF can send the one or more alternative QoS profiles in a form of a list (for example, alternative QoSs) to the access network function entity.

In other implementations, in S202, the access network function entity may also determine the first QoS profile according to the UE status information and an association relationship between UE status information and QoS profiles.

It can be understood that the access network function entity or the PCF can configure the association relationship between the UE status information and the QoS profiles. In S202, the access network function entity can determine the QoS profile for the one or more QoS flows associated with the UE according to the UE status information from the AF by querying the association relationship between the UE status information and the QoS profiles.

In some implementations, the PCF can send the association relationship between the UE status information and the QoS profiles to the access network function entity. Or, the access network function entity can configure the above association relationship according to a local policy and/or an operator policy. The access network function entity can also obtain the above association relationship in other ways, which is not specifically limited in the embodiments of the present disclosure.

In S203, the access network function entity performs a QoS update based on the first QoS profile.

It can be understood that the access network function entity, after determining the corresponding first QoS profile according to the power consumption status of the UE, performs a QoS update on the one or more QoS flows associated with the UE by using the first QoS profile.

In S204, the access network function entity sends the first QoS profile to an SMF.

It can be understood that in order to unify QoS profile, the access network function entity can send the first QoS profile to the UE, the 5GC (including the AMF, the SMF and/or the PCF), and the AF after determining the first QoS profile. For example, the access network function entity can send the first QoS profile to the UE, the 5GC (including the AMF, the SMF and/or the PCF), and the AF by initiating a packet data unit (PDU) session modification procedure. In the PDU session modification procedure, the access network function entity first sends the first QoS profile to the SMF, then the SMF sends it to the AMF and the PCF, and the PCF sends the received first QoS profile to the AF. In addition, the SMF can also send the first QoS profile to the UE. After receiving the first QoS profile, the UE, the AMF, the SMF, the PCF, and the AF can perform a QoS update according to the first QoS profile.

In some implementations, when sending the first QoS profile to the PCF through the SMF in S204, the access network function entity can also send the UE status information corresponding to the first QoS profile (i.e., the UE status information from the AF) to the PCF, so that the PCF can decide whether the first QoS profile is suitable for the current power consumption status of the UE based on the latest UE status information received by itself and the UE status information sent by the access network function entity, and determine whether to provide a more suitable alternative QoS profile to the access network function entity, adjust QOS policies, etc., thereby optimizing QoS control.

For example, in S204, the access network function entity sends the first QoS profile to the SMF through a NAS message (for example, N2 SM information).

It should be noted that the above S203 and S204 can be executed simultaneously, or S203 can be executed first and then S204 is executed, which is not specifically limited in the embodiments of the present disclosure.

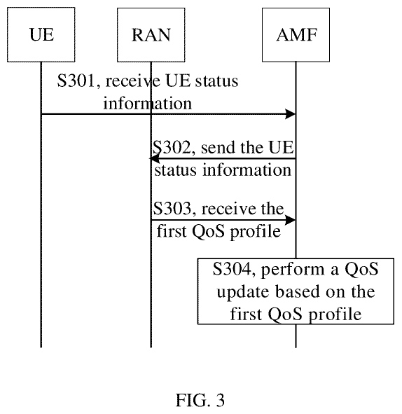

FIG. 3 is a schematic diagram of an implementation procedure of a second QoS flow control method according to an embodiment of the present disclosure. As shown in FIG. 3, in this embodiment, the method is applied to a first core network function entity (for example, an AMF) side, and the method can include S301 to S304.

In S301, the AMF receives terminal status information (UE status information) sent by a UE.

The UE status information is used to represent a power consumption status of the UE. For example, the UE status information includes one or more parameters related to UE performance. For example, the UE status information may include at least one of the following: a UE battery level, a UE battery life, a UE powered mode, a UE CPU load, a UE overheating status. In an embodiment of the present disclosure, parameters related to UE power consumption may include others. Here, the UE powered mode can include a battery-powered mode and a mains/wall-powered mode. Here, the battery-powered mode refers to using a built-in battery of the UE for power supply, and the mains/wall-powered mode refers to using a power adapter to connect to, for example, a wall socket, a mobile socket or the like, so as to connect to a power source to supply power to the UE.

It should be understood that the UE can report its UE status information to the AMF, and then the AMF reports the UE status information to an access network function entity.

In an embodiment, in order to have no impact on the access network function entity and UE interfaces as far as possible, the UE may send the UE status information to the AMF through a NAS message (for example, N2 SM information).

It should be noted that the above S301 can be multiplexed with a UE registration procedure, a UE triggered service request procedure, etc. The above S301 can also be multiplexed in other procedures, which is not specifically limited in the embodiments of the present disclosure.

In S302, the AMF sends the UE status information to the access network function entity.

The UE status information is further configured for the access network function entity to determine a first QoS profile for one or more QoS flows associated with the UE from one or more alternative QoS profiles.

It can be understood that after receiving the UE status information of the UE, the AMF can provide it to the access network function entity. For example, the AMF can send the UE status information to the access network function entity through a NAS message (for example, N2 SM information).

As an example, the above S302 can be multiplexed with a PDU session establishment procedure. The above S302 can also be multiplexed in other procedures, which is not specifically limited in the embodiments of the present disclosure.

Here, the one or more QoS flows associated with the UE can be related to the first service. In an embodiment of the present disclosure, the first service may be an XRM service or an XRM service group.

In some implementations, the above QoS flows may be of different granularities, for example, QOS flows for sessions (i.e., session QoS flows), QoS flows for services (e.g., QoS flows of service data flows), which is not specifically limited in the embodiments of the present disclosure.

It can be understood that the access network function entity can determine corresponding QoS parameters for one or more sessions of a service (i.e., the first service) of the UE according to the UE status information. Or, the PCF can determine the corresponding QOS parameters for a service (i.e., the first service) of the UE according to the UE status information. Here, “determine” can be described as “set”, “generate”, “update”, etc.

In some implementations, after S302, the above method may further include S303 to S304.

In S303, the AMF receives the first QoS profile from the access network function entity.

It can be understood that after determining the first QoS profile from the alternative QoS profiles, the access network function entity can send the first QoS profile to an SMF, and then the SMF send the first QoS profile to the AMF. Or, the access network function entity can directly send the first QoS profile to the AMF. For example, the access network function entity can send the first QoS profile to the AMF through a NAS message (for example, N1 message).

It should be noted that the above S303 can be multiplexed with a PDU session modification procedure. The above S303 can also be multiplexed in other procedures, which is not specifically limited in the embodiments of the present disclosure.

In S304, the AMF performs a QoS update based on the first QoS profile.

It can be understood that after receiving the first QoS profile determined according to the power consumption status of the UE, the AMF performs a QoS update on the one or more QoS flows associated with the UE by using the first QoS profile.

In the embodiment of the present disclosure, the execution process of the AMF can also refer to the description of the execution process of the AMF in the embodiments of FIG. 1 above, and will not be repeated here for the sake of brevity.

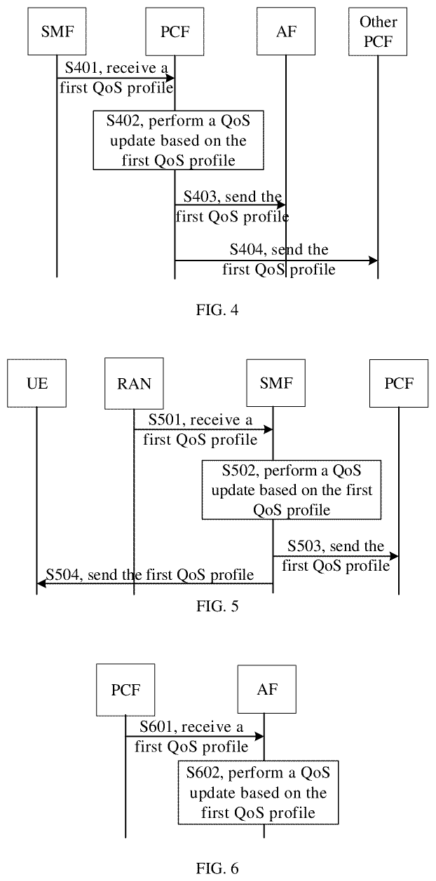

FIG. 4 is a schematic diagram of an implementation procedure of a third QoS flow control method according to an embodiment of the present disclosure. As shown in FIG. 4, in this embodiment, the method is applied to a third core network function entity (for example, a PCF) side, and the method can include S401 to S404.

In S401, the PCF receives a first QoS profile from an SMF.

It can be understood that after receiving the first QoS profile sent by an access network function entity, the SMF can provide the first QoS profile to the PCF.

In an embodiment of the present disclosure, the first QoS profile is a QoS profile for one or more QoS flows associated with a UE determined by the access network function entity from one or more alternative QoS profiles according to UE status information of the UE.

Here, the one or more QoS flows associated with the UE can be related to the first service. In an embodiment of the present disclosure, the first service may be an XRM service or an XRM service group.

In some implementations, the above QoS flows may be of different granularities, for example, QOS flows for sessions (i.e., session QoS flows), QoS flows for services (e.g., QoS flows of service data flows), which is not specifically limited in the embodiments of the present disclosure.

It can be understood that the access network function entity can determine the corresponding QoS profile for one or more sessions of a service (i.e., the first service) of the UE according to the UE status information. Or, the PCF can determine the corresponding QoS profile for a service (i.e., the first service) of the UE according to the UE status information. Here, “determine” can be described as “set”, “generate”, “update”, etc.

In some implementations, before S401, the PCF can also send one or more alternative QoS profiles to the access network function entity. In this way, after receiving the UE status information of the UE, the access network function entity can select a QoS profile (i.e., the first QoS profile) for one or more QoS flows associated with the UE from the one or more alternative QoS profiles according to the power consumption status of the UE, so as to perform a QoS update according to this QoS profile.

In some implementations, the one or more alternative QoS profiles mentioned above may be sent by an AF to the PCF.

In an embodiment, after receiving alternative QoS profiles sent by the AF, the PCF can also determine the one or more alternative QoS profiles to be sent to the access network function entity according to QoS policies.

In some implementations, the PCF can send the one or more alternative QoS profiles in a form of a list (for example, alternative QoSs) to the access network function entity.

In some implementations, in S401, the PCF can send a subscription request message to the SMF, where the subscription request message is configured to request a first event associated with the first QoS profile. If the first event satisfies an event reporting condition, the PCF receives the first QoS profile sent by the SMF.

It can be understood that the PCF can subscribe to the SMF for an event associated with the first QoS profile. After receiving the first QoS profile, the SMF queries subscription events and confirms the event associated with the first QoS profile. When the event satisfies the reporting condition, the SMF sends the first QoS profile to the PCF. The PCF can also obtain the first QoS profile from the SMF in other ways, which is not specifically limited in the embodiments of the present disclosure.

In S402, the PCF performs a QoS update based on the first QoS profile.

It can be understood that after receiving the first QoS profile determined according to the power consumption status of the UE, the PCF performs a QoS update on the one or more QoS flows associated with the UE by using the first QoS profile.

In S403, the PCF sends the first QoS profile to the AF for the AF to perform a QOS update.

In some implementations, the PCF can, and is not limited to, send the first QoS profile to the AF through the following paths.

In a first path, the PCF directly sends the first QoS profile to the AF. It can be understood that the PCF can send the first QoS profile to the AF through Npcf and Naf. In this case, the AF is a trusted AF.

In a second path, the PCF sends the first QoS profile to the AF through a NEF. It can be understood that the PCF can send the first QoS profile to the NEF through Npcf and Nnef, and the NEF sends the first QoS profile to the AF through Nnef and Naf. In this case, the AF is an untrusted AF.

In a third path, the PCF sends the first QoS profile to the AF through a TSCTSF. It can be understood that the PCF can send the first QoS profile to the TSCTSF through Npcf and Ntsctsf, and the TSCTSF sends the first QoS profile to the AF through Ntsctsf and Naf. In this case, the AF is a trusted AF, and the first service is a time sensitive service.

In a fourth path, the PCF sends the first QoS profile to the AF through a NEF and a TSCTSF. It can be understood that the PCF can send the first QoS profile to the NEF through Npcf and Nnef, and the NEF sends the first QoS profile to the TSCTSF through Nnef and Ntsctsf. Then the TSCTSF sends the first QoS profile to the AF through Ntsctsf and Naf. In this case, the AF is an untrusted AF, and the first service is a time sensitive service.

From the first to fourth manners mentioned above, it can be seen that for different types of AFs and/or types of the first service, one or more network functions (NFs), for example, the above NEF, the TSCTSF and the like, can be set between the PCF and the AF. Correspondingly, there may be different transmission paths for the first QoS profile. It should be noted that the above is only examples of the transmission paths for the first QoS profile and does not limit the transmission manner and the transmission path for the first QoS profile. The first QoS profile can also be transmitted from the PCF to the AF through other paths.

With the evolution of the communication system, there may be other deployment situations for the above NFs, which is not specifically limited in the embodiments of the present disclosure.

In some implementations, after receiving the first QoS profile sent by the AF, the NEF can also send the first QoS profile to a user data repository (UDR) function entity or a unified data management (UDM) function entity, so as to store the first QoS profile as an AMF associated parameter, an SMF associated parameter, or a service characteristic parameter of application data.

It should be noted that the above S402 and S403 can be executed simultaneously, or S402 can be executed first and then S403 is executed, which is not specifically limited in the embodiments of the present disclosure.

It should be noted that the above S401 and S403 can be multiplexed with a PDU session modification procedure. The above S401 and S403 can also be multiplexed in other procedures, which is not specifically limited in the embodiments of the present disclosure.

In some implementations, after S401, the above method may also include S404.

In S404, the PCF can also send the first QoS profile to other PCFs, where the first QoS profile is used for other PCFs to perform a QoS update on one or more QoS flows.

It should be understood that in a multi-UE scenario, different UEs can correspond to different PCFs. So, when a PCF (which can be referred to as PCF 0) receives the first QoS profile from the access network function entity, it can provide the first QoS profile to other PCFs (for example, PCF 1, PCF 2, PCF 3, . . . ) for other PCFs to perform the QoS update process as described in S404 above.

As an example, the PCF 0 can directly send the first QoS profile to other PCFs such as the PCF 1, PCF 2, PCF 3 after receiving the first QoS profile. Or, other PCFs such as the PCF 1, PCF 2, PCF 3 can also subscribe to the PCF 0 for an event associated with the first QoS profile (i.e., the first event). When the first event satisfies a reporting condition, the PCF 0 sends the first QoS profile to other PCFs such as the PCF 1, PCF 2, PCF 3. Or, all PCFs subscribe to the NEF for the event associated with the first QoS profile. If the event satisfies the reporting condition, the NEF sends the first QoS profile to all PCFs. The multiple PCFs can also obtain the first QoS profile in other ways, which is not specifically limited in the embodiments of the present disclosure.

In the embodiment of the present disclosure, the execution process of the PCF can also refer to the description of the execution process of the PCF side in the embodiments of FIGS. 2 and 3 above, and will not be repeated here for the sake of brevity.

In some embodiments, the present disclosure also provides a QoS flow control method. FIG. 5 is a schematic diagram of an implementation procedure of a fourth QoS flow control method according to an embodiment of the present disclosure. As shown in FIG. 5, in this embodiment, the method is applied to a second core network function entity (for example, an SMF) side, and the method can include S501 to S504.

In S501, the SMF receives a first QoS profile sent by an access network function entity.

The first QoS profile is a QoS profile for one or more QoS flows associated with a UE determined by the access network function entity from one or more alternative QoS profiles according to UE status information of the UE.

It can be understood that after determining the corresponding first QoS profile according to the UE status information provided by an AMF, the access network function entity sends the first QoS profile to the SMF, and the SMF forwards the first QoS profile to the UE, 5GC, and AF.

In an embodiment, the access network function entity may send the first QoS profile to the SMF through a NAS message (such as N2 SM information).

After S501, the SMF can perform at least one of S502 to S504.

In S502, the SMF performs a QoS update based on the first QoS profile.

In S503, the SMF sends the first QoS profile to a PCF, where the first QoS profile is used for the PCF and/or the AF to perform a QoS update.

In S504, the SMF sends the first QoS profile to the UE, where the first QoS profile is used for the UE to perform a QoS update.

It should be noted the above S501 to S504 can be multiplexed with a PDU session modification procedure. The above S501 to S504 can also be multiplexed in other procedures, which is not specifically limited in the embodiments of the present disclosure.

In addition, S502, S503, and S504 can be executed simultaneously or sequentially, which is not specifically limited in the embodiments of the present disclosure.

In the embodiment of the present disclosure, the execution process of the SMF can also refer to the description of the execution process of the SMF in the embodiments of FIGS. 2 to 4 above, and will not be repeated here for the sake of brevity.

In some embodiments, the present disclosure also provides a QoS flow control method. FIG. 6 is a schematic diagram of an implementation procedure of a fifth QoS flow control method according to an embodiment of the present disclosure. As shown in FIG. 6, in this embodiment, the method is applied to an application function entity (for example, an AF) side, and the method can include S601 to S602.

In S601, the AF receives a first QoS profile sent by a PCF.

In some implementations, in S601, the AF can send a subscription request message to the PCF, where the subscription request message is configured to request a first event associated with the first QoS profile. If the first event satisfies an event reporting condition, the AF receives the first QoS profile sent by the PCF.

In S602, the AF performs a QoS update based on the first QoS profile.

In the embodiment of the present disclosure, the execution process of the AF can refer to the description of the execution process of the AF in the embodiments of FIGS. 2 to 5 above, and will not be repeated here for the sake of brevity.

Thus, the QoS control process for QoS flows is implemented.

In the embodiment of the present disclosure, the UE status information of the UE is provided to the access network function entity through the AMF entity, so that the access network function entity can match service traffic characteristics and terminal energy consumption management according to the UE status information, that is, select the corresponding QoS profile according to the power consumption status of the terminal, so as to ensure service requirements and user experience. Furthermore, the UE status information provided by the AMF as additional information for policy determination can reduce the use of wireless interface network resources, especially in situations where resources are limited. Further, the UE status information of the UE is provided to the access network function entity through the AMF entity, which can support the use of network resources according to capabilities of the terminal. Further, the UE status information of the UE is provided to the access network function entity through the AMF entity, so that the user's critical application programs are allowed to run in the power saving mode, thereby improving the user experience and prolonging the battery life, instead of completely shutting down.

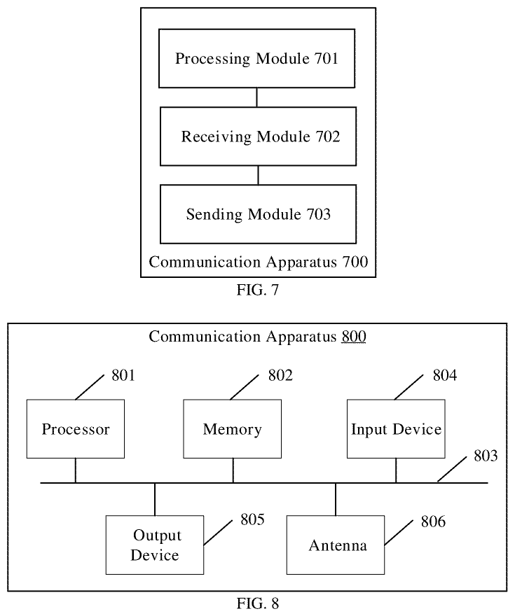

Based on the same inventive concept, an embodiment of the present disclosure provides a communication apparatus. FIG. 7 is a schematic structural diagram of a communication apparatus according to an embodiment of the present disclosure. Referring to FIG. 7, a communication apparatus 700 can include a processing module 701, a receiving module 702, and a sending module 703.

In some embodiments, the communication apparatus 700 may be an access network function entity or a chip or a system on chip (SoC) of the access network function entity in a communication system, or a function module for implementing the methods described in the above embodiments in the access network function entity. The communication apparatus 700 can implement the functions performed by the access network function entity in the above embodiments, which can be implemented by hardware executing corresponding software. These hardware or software includes one or more modules corresponding to the above functions.

Correspondingly, the receiving module 702 is configured to receive terminal status information from a first core network function entity, where the terminal status information is configured to represent a power consumption status of a terminal. The processing module 701 is configured to determine a first QoS profile for one or more QoS flows associated with the terminal from one or more alternative QoS profiles according to the terminal status information. The sending module 703 is configured to send the first QoS profile to a second core network function entity, where the first QoS profile is configured for at least one of the terminal, the second core network function entity, a third core network function entity, or an application function (AF) entity to perform a QoS update.

In some implementations, the terminal status information includes at least one of: a battery level; a battery life; a powered mode; a central processing unit (CPU) load; or a terminal overheating status.

In some implementations, the one or more alternative QoS profiles include at least one of: a packet delay budget; a packet error rate; an uplink (UL) guaranteed bitrate; a downlink (DL) guaranteed bitrate; an averaging window; a maximum data burst volume; or a terminal status management indication, configured to indicate whether the one or more alternative QoS profiles support application to terminal status management.

In some implementations, the processing module 701 is configured to determine the first QoS profile according to the terminal status information and the terminal status management indication in the one or more alternative QoS profiles.

In some implementations, the processing module 701 is configured to determine the first QoS profile according to the terminal status information and an association relationship between configured terminal status information and QoS profiles.

In some implementations, the receiving module 702 is configured to receive the association relationship sent by the second core network function entity; or, the access network function entity configures the association relationship according to a local policy and/or an operator policy.

In some implementations, the processing module 701 is configured to perform a QoS update on the one or more QoS flows associated with the terminal according to the first QoS profile.

In some implementations, the receiving module 702 is configured to receive the one or more alternative QoS profiles sent by the second core network function entity.

In some implementations, the receiving module 702 is configured to receive a non access stratum (NAS) message sent by the first core network function entity, where the NAS message carries the terminal status information.

In some implementations, sending, by the access network function entity, the first QoS profile to the second core network function entity includes: sending, by the access network function entity, a non access stratum (NAS) message to the second core network function entity, where the NAS message carries the first QoS profile.

In some embodiments, the communication apparatus 700 may be a first core network function entity or a chip or a SoC of the first core network function entity in a communication system, or a function module for implementing the methods described in the above embodiments in the first core network function entity. The communication apparatus 700 can implement the functions performed by the first core network function entity in the above embodiments, which can be implemented by hardware executing corresponding software. These hardware or software includes one or more modules corresponding to the above functions.

Correspondingly, the receiving module 702 is configured to receive terminal status information sent by a terminal, where the terminal status information is configured to represent a power consumption status of a terminal. The sending module 703 is configured to send the terminal status information to an access network function entity, where the terminal status information is further configured for the access network function entity to determine a first QoS profile for one or more QoS flows associated with the terminal from one or more alternative QoS profiles, where the first QoS profile is configured for the terminal, a second core network function entity, a third core network function entity, and an application function (AF) entity to perform a QoS update.

In some implementations, the terminal status information includes at least one of: a battery level; a battery life; a powered mode; a central processing unit (CPU) load; or a terminal overheating status.

In some implementations, the one or more alternative QoS profiles include at least one of: a packet delay budget; a packet error rate; an uplink (UL) guaranteed bitrate; a downlink (DL) guaranteed bitrate; an averaging window; a maximum data burst volume; or a terminal status management indication, configured to indicate whether the one or more alternative QoS profiles support application to terminal status management.

In some implementations, the sending module 703 is configured to send a first request message to the terminal, where the first request message is configured to request the terminal status information.

In some implementations, the receiving module 702 is configured to receive a non access stratum (NAS) message sent by the terminal, where the NAS message carries the terminal status information.

In some implementations, the above apparatus further includes a processing module 701; where the receiving module 702 is configured to receive the first QoS profile sent by the access network function entity; and the processing module 701 is configured to perform a QoS update on the one or more QoS flows associated with the terminal according to the first QoS profile.

In some implementations, the receiving module 702 is configured to receiving a non access stratum (NAS) message sent by the access network function entity, where the NAS message carries the first QoS profile.

In some embodiments, the communication apparatus 700 may be a third core network function entity or a chip or a SoC of the third core network function entity in a communication system, or a function module for implementing the methods described in the above embodiments in the third core network function entity. The communication apparatus 700 can implement the functions performed by the third core network function entity in the above embodiments, which can be implemented by hardware executing corresponding software. These hardware or software includes one or more modules corresponding to the above functions.

Correspondingly, the receiving module 702 is configured to receive a first QoS profile sent by an access network function entity, where the first QoS profile is a QoS profile for one or more QoS flows associated with a terminal determined by the access network function entity from one or more alternative QoS profiles according to terminal status information of the terminal. The communication apparatus also includes at least one of the following: a processing module 701 configured to perform a QoS update on the one or more QoS flows associated with the terminal according to the first QoS profile; or a sending module 703 configured to send the first QoS profile to an application function (AF) entity, where the first QoS profile is configured for the AF entity to perform a QoS update.

In some implementations, the terminal status information includes at least one of: a battery level; a battery life; a powered mode; a central processing unit (CPU) load; or a terminal overheating status.

In some implementations, the one or more alternative QoS profiles include at least one of: a packet delay budget; a packet error rate; an uplink (UL) guaranteed bitrate; a downlink (DL) guaranteed bitrate; an averaging window; a maximum data burst volume; or a terminal status management indication, configured to indicate whether the one or more alternative QoS profiles support application to terminal status management.

In some implementations, the receiving module 702 is configured to receive the first QoS profile sent by a second core network function entity, where the first QoS profile is sent by the access network function entity to the second core network function entity.

In some implementations, the sending module 703 is configured to send a subscription request message to the second core network function entity, where the subscription request message is configured to request a first event associated with the first QoS profile; and the receiving module 702 is configured to receive the first QoS profile sent by the second core network function entity if the first event satisfies an event reporting condition

In some implementations, the sending module 703 is configured to send the first QoS profile to a fourth core network function entity, where the first QoS profile is configured for the fourth core network function entity to perform a QoS update.

In some implementations, the receiving module 702 is configured to receive the one or more alternative QoS profiles sent by the AF entity.

In some implementations, the sending module 703 is configured to send the one or more alternative QoS profiles to the access network function entity.

In some embodiments, the communication apparatus 700 may be a second core network function entity or a chip or a SoC of the second core network function entity in a communication system, or a function module for implementing the methods described in the above embodiments in the second core network function entity. The communication apparatus 700 can implement the functions performed by the second core network function entity in the above embodiments, which can be implemented by hardware executing corresponding software. These hardware or software includes one or more modules corresponding to the above functions.

Correspondingly, the receiving module 702 is configured to receive a first QoS profile sent by an access network function entity, where the first QoS profile is a QoS profile for one or more QoS flows associated with a terminal determined by the access network function entity from one or more alternative QoS profiles according to terminal status information of the terminal. The communication apparatus also includes at least one of the following: a processing module 701 configured to perform a QOS update on the one or more QoS flows associated with the terminal according to the first QoS profile; or a sending module 703 configured to send the first QoS profile to the terminal and/or a third core network function entity, where the first QoS profile is configured for one or more of the terminal, the third core network function entity, and the AF entity to perform a QoS update.

In some implementations, the terminal status information includes at least one of: a battery level; a battery life; a powered mode; a central processing unit (CPU) load; or a terminal overheating status.

In some implementations, the one or more alternative QoS profiles include at least one of: a packet delay budget; a packet error rate; an uplink (UL) guaranteed bitrate; a downlink (DL) guaranteed bitrate; an averaging window; a maximum data burst volume; or a terminal status management indication, configured to indicate whether the one or more alternative QoS profiles support application to terminal status management.

In some implementations, the processing module 701 is configured to query subscription events to determine a first event associated with the first QoS profile; and the sending module 703 is configured to send the first QoS profile to the third core network function entity if the first event satisfies an event reporting condition.

In some implementations, the sending module 703 is configured to send a non access stratum (NAS) message to the terminal, where the NAS message carries the first QoS profile.

It should be noted that the specific implementation processes of the processing module 701, the receiving module 702, and the sending module 703 can refer to the detailed descriptions of the embodiments in FIGS. 2 to 6, and are not repeated here for the sake of brevity.

The receiving module 702 mentioned in the embodiments of the present disclosure can be a receiving interface, a receiving circuit, or a receiver, etc. The sending module 703 can be a sending interface, a sending circuit, or a transmitter, etc. The processing module 701 can be one or more processors.

Based on the same inventive concept, an embodiment of the present disclosure provides a communication apparatus, which can be the first core network function entity or the application function entity as described in one or more of the above embodiments. FIG. 8 is a schematic structural diagram of a communication apparatus in an embodiment of the present disclosure. Referring to FIG. 8, the communication apparatus 800 adopts general computer hardware, including a processor 801, a memory 802, a bus 803, an input device 804, and an output device 805.

In some implementations, the memory 802 can include computer storage media in the form of volatile and/or non-volatile memory, such as read-only memory and/or random access memory. The memory 802 can store operating systems, application programs, other program modules, executable codes, program data, user data, etc.

The input device 804 may be used to input instructions and information to the communication apparatus. The input device 804 may be a keyboard or a pointing device, such as a mouse, a trackballs, a touchpad, a microphone, a joystick, a game pad, a satellite television antenna, a scanner, or other devices. These input devices may be connected to the processor 801 via the bus 803.

The output device 805 may be used for the communication apparatus to output information. In addition to a monitor, the output device 805 may be other peripheral output devices, such as speakers and/or printing devices, which may also be connected to the processor 801 via the bus 803.

The communication apparatus may be connected to the network, such as a local area network (LAN), via an antenna 806. In a networked environment, computer executable instructions stored in a control device may be stored in a remote storage device, which is not limited to local storage.

When the processor 801 in the communication apparatus executes the executable codes or application programs stored in the memory 802, the communication apparatus executes the QoS flow control method or on the network device side in the above embodiments, and the specific execution process is described with reference to the above embodiments, and will not be repeated herein.

In addition, the above memory 802 stores computer executable instructions for implementing the functions of the processing module 701, the receiving module 702, and the sending module 703 in FIG. 7. The functions/implementation processes of the processing module 701, the receiving module 702, and the sending module 703 in FIG. 7 can all be achieved by the processor 801 in FIG. 8 calling the computer executable instructions stored in the memory 802. The specific implementation process and functions refer to the relevant embodiments mentioned above.

Based on the same inventive concept, an embodiment of the present disclosure provides a network function entity, such as an access network function entity, a first core network function entity, a second core network function entity, or a third core network function entity.

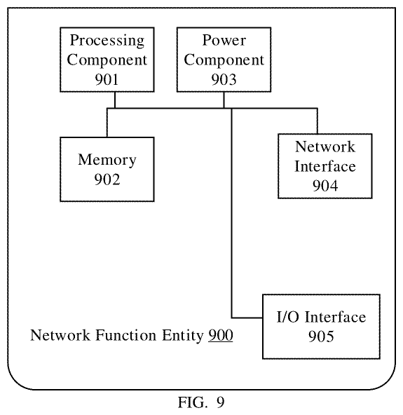

FIG. 9 is a schematic structural diagram of a network function entity according to an embodiment of the present disclosure. Referring to FIG. 9, the network function entity 900 may include a processing component 901, which further includes one or more processors, and memory resources represented by a memory 902, for storing instructions that can be executed by the processing component 901, such as an application program. The application program stored in memory 902 may include one or more modules each corresponding to a set of instructions. In addition, the processing component 901 is configured to execute the instructions to perform any one of the aforementioned methods applied to the network device.

The network function entity 900 may also include a power component 903 configured to perform power management for the network function entity 900, a wired or wireless network interface 904 configured to connect the network function entity 900 to a network, and an input/output (I/O) interface 905. The network function entity 900 can operate based on an operating system stored in the memory 902, such as Windows Server™, Mac OS X™, Unix™, Linux™, FreeBSD™, or the like.

Based on the same inventive concept, an embodiment of the present disclosure also provides a communication apparatus, for example, an access network function entity, a first core network function entity, a second core network function entity, or a third core network function entity, including a memory and a processor. The processor is connected to the memory and configured to execute computer executable instructions stored on the memory to implement the method described in one or more of the above embodiments.

Based on the same inventive concept, an embodiment of the present disclosure also provides a computer readable storage medium, in which instructions are stored. When executed on a computer, the instructions are used to execute the QoS flow control method on the network function entity side in one or more of the above embodiments. Here, the network function entity may include, for example, the access network function entity, the first core network function entity, the second core network function entity, or the third core network function entity.

Based on the same inventive concept, an embodiment of the present disclosure also provide a computer program or computer program product that, when executed on a computer, causes the computer to implement the QoS flow control method on the network function entity side in one or more of the above embodiments. Here, the network function entity may include, for example, the access network function entity, the first core network function entity, the second core network function entity, or the third core network function entity.

Those skilled in the art will readily contemplate other embodiments of the present disclosure upon consideration of the specification and practice of the present disclosure disclosed herein. The present disclosure is intended to cover any variations, uses, or adaptions of the present disclosure that conform to the general principles of the present disclosure and include common knowledge or conventional technical means in the technical field which are not disclosed in the present disclosure. It is intended that the description and embodiments shall be considered as illustrative only, and the true scope and spirit of the present disclosure are indicated by the appended claims.

It should be understood that the present disclosure is not limited to the precise structures that have been described above and shown in the accompanying drawings, and various modifications and changes can be made without departing from the scope thereof. The scope of the present disclosure is defined only by the appended claims.

1. A quality of service (QOS) flow control method, applied to performed by an access network function, the method comprising:
receiving terminal status information from a first core network function, wherein the terminal status information is configured to represent a power consumption status of a terminal;
determining a first QoS profile for one or more QoS flows associated with the terminal from one or more alternative QoS profiles according to the terminal status information; and
sending the first QoS profile to a second core network function, wherein the first QoS profile is configured for at least one of the terminal, the second core network function, a third core network function, or an application function (AF) to perform a QoS update.

2. The method according to claim 1, further comprising at least one of:
the first core network function comprising an access and mobility management function (AMF), the second core network function comprising a session management function (SMF), and the third core network function comprising a policy control function (PCF); or
the terminal status information comprising at least one of: a battery level; a battery life; a powered mode; a central processing unit (CPU) load; or a terminal overheating status.

3. (canceled)

4. The method according to claim 1, wherein the one or more alternative QoS profiles comprise at least one of:
a packet delay budget;
a packet error rate;
an uplink guaranteed bitrate;
a downlink guaranteed bitrate;
an averaging window;
a maximum data burst volume; or
a terminal status management indication, configured to indicate whether the one or more alternative QoS profiles support application to terminal status management.

5. The method according to claim 4, wherein determining the first QoS profile for the one or more QoS flows associated with the terminal from the one or more alternative QoS profiles according to the terminal status information comprises:
determining the first QoS profile according to the terminal status information and the terminal status management indication in the one or more alternative QoS profiles.

6. The method according to claim 1, wherein determining the first QoS profile for the one or more QoS flows associated with the terminal from the one or more alternative QoS profiles according to the terminal status information comprises:
determining the first QoS profile according to the terminal status information and an association relationship between configured terminal status information and QoS profiles;
wherein the method further comprises:
receiving the association relationship sent by the second core network function; or
configuring the association relationship according to a local policy and/or an operator policy.

7. (canceled)

8. The method according to claim 1, further comprising at least one of:
performing a QoS update on the one or more QoS flows associated with the terminal according to the first QoS profile; or
receiving the one or more alternative QoS profiles sent by the second core network function.

9. (canceled)

10. The method according to claim 1, further comprising at least one of:
receiving the terminal status information from the first core network function comprising: receiving a non access stratum (NAS) message sent by the first core network function, wherein the NAS message carries the terminal status information; or
sending the first QoS profile to the second core network function comprising:
sending a NAS message to the second core network function, wherein the NAS message carries the first QoS profile.

11. (canceled)

12. A quality of service (QOS) flow control method, performed by a first core network function, the method comprising:
receiving terminal status information sent by a terminal, wherein the terminal status information is configured to represent a power consumption status of the terminal; and
sending the terminal status information to an access network function, wherein the terminal status information is further configured for the access network function to determine a first QoS profile for one or more QoS flows associated with the terminal from one or more alternative QoS profiles, wherein the first QoS profile is configured for the terminal, a second core network function, a third core network function, and an application function (AF) to perform a QoS update.

13.-15. (canceled)

16. The method according to claim 12, further comprising at least one of:
sending a first request message to the terminal, wherein the first request message is configured to request the terminal status information; or
receiving a non access stratum (NAS) message sent by the terminal, wherein the NAS message carries the terminal status information.

17. (canceled)

18. The method according to claim 12, further comprising:
receiving the first QoS profile sent by the access network function; and
performing a QoS update on the one or more QoS flows associated with the terminal according to the first QoS profile;
wherein receiving the first QoS profile sent by the access network function comprises:
receiving a non access stratum (NAS) message sent by the access network function, wherein the NAS message carries the first QoS profile.

19. (canceled)

20. A quality of service (QOS) flow control method, performed by a third core network function, the method comprising:
receiving a first QoS profile sent by an access network function, wherein the first QoS profile is a QoS profile for one or more QoS flows associated with a terminal determined by the access network function from one or more alternative QoS profiles according to terminal status information of the terminal; and
performing, by the third core network function, at least one of:
performing a QoS update on the one or more QoS flows associated with the terminal according to the first QoS profile; or
sending the first QoS profile to a fourth core network function and/or an application function (AF), wherein the first QoS profile is configured for the fourth core network function and/or the AF to perform a QoS update.

21.-23 (canceled)

24. The method according to claim 20, further comprising:
receiving the first QoS profile sent by a second core network function, wherein the first QoS profile is sent by the access network function to the second core network function.

25. The method according to claim 24, wherein receiving the first QoS profile sent by the second core network function comprises:
sending a subscription request message to the second core network function, wherein the subscription request message is configured to request a first event associated with the first QoS profile; and
receiving the first QoS profile sent by the second core network function if the first event satisfies an event reporting condition.

26. The method according to claim 20, further comprising at least one of:
receiving the one or more alternative QoS profiles sent by the AF; or
sending the one or more alternative QoS profiles to the access network function.

27.-39. (canceled)

40. A communication apparatus, comprising:
a memory; and
one or more processors, wherein the one or more processors are connected to the memory and configured to perform the method according to claim 1.

41. (canceled)

42. A communication apparatus, comprising:
a memory; and
one or more processors, wherein the one or more processors are connected to the memory and configured to perform the method according to claim 12.

43. A communication apparatus, comprising:
a memory; and
one or more processors, wherein the one or more processors are connected to the memory and configured to perform the method according to claim 20.

44. A non-transitory computer storage medium storing computer executable instructions that, when executed by a processor, cause the processor to perform the method according to claim 1.

45. A non-transitory computer storage medium storing computer executable instructions that, when executed by a processor, cause the processor to perform the method according to claim 12.

46. A non-transitory computer storage medium storing computer executable instructions that, when executed by a processor, cause the processor to perform the method according to claim 20.
